(19) United States
(12) Patent Application Publication
(10) Pub. No.: US 2014/0089899 A1
(43) Pub. Date: Mar. 27, 2014

(54) METHOD FOR THE COMPUTER-ASSISTED ANALYSIS OF BUGGY SOURCE CODE IN A HARDWARE DESCRIPTION LANGUAGE

(71) Applicants: Gorschwin Fey, Bremen (DE); André Sülflow, Bremen (DE); Rolf Drechsler, Bremen (DE)

(72) Inventors: Gorschwin Fey, Bremen (DE); André Sülflow, Bremen (DE); Rolf Drechsler, Bremen (DE)

(73) Assignee: UNIVERSITÄT BREMEN, Bremen (DE)

(21) Appl. No.: 14/119,167

(22) PCT Filed: Jun. 5, 2012
(86) PCT No.: PCT/EP2012/060585

§ 371 Date: Nov. 20, 2013

(30) Foreign Application Priority Data
Jun. 8, 2011 (DE) 10 2011 077 177.8

(51) Int. Cl. G06F 11/36

(52) U.S. Cl. CPC G06F 11/3624
USPC 717/125

(57) ABSTRACT

The invention relates to a method for the computer-assisted analysis of buggy source code in a hardware description language describing the structure and the operation of an integrated circuit. A correction model is provided, which includes a hierarchical structure of nodes arranged in a plurality of hierarchical levels, the nodes being transformation instructions, wherein a transformation instruction describes a group of transformations which are applied to at least one type of a source code section and thereby change the source code section and wherein a transformation instruction, which is a child node of another transformation instruction, constitutes a subset of the group of transformations of the other transformation instruction. Those transformation instructions, which change the source code in such a manner that the changed source code leads to a correct output of the integrated circuit, are determined and output together with the associated source code sections as corrections.

The invention relates to a method for the computer-assisted analysis of buggy source code in a hardware description language and also a corresponding computer program product and a corresponding computer program.

The invention lies in the technical field of simulating integrated circuits with the aid of hardware description languages. Hardware description languages have been known from the prior art for a long time. Using these languages, a source code is generated on the basis of a corresponding syntax, which specifies the design of the circuit and the operations carried out therewith. Using such a source code, the behaviour of the integrated circuit can be simulated by means of corresponding input sequences. Corresponding outputs are generated by the circuit in the course of the simulation. If the generated outputs deviate from expected outputs that should be generated with the circuit design, a bug is present in the source code. Manually locating such bugs by the designer of the integrated circuit (also termed debugging) is generally very time-consuming and there is a requirement to support the designer in detecting bugs in the source code with an automated method.

A method is described in document U.S. Pat. No. 5,862,361 A, in which a source code is generated in the hardware description languages VHDL or Verilog from a functional description of a hardware component. This source code can then be simulated efficiently.

Document DE 102 43 598 A1 discloses a method for functionally verifying integrated circuits, by which errors in the circuit design can be detected.

Document US 2009/0125766 A1 discloses diagnostic methods for hardware debugging. The computation of possible bug locations is described on the basis of Boolean satisfiability. Furthermore, additions are specified based on quantified Boolean formulae, hierarchical knowledge, abstraction and unsatisfiable cores.

It is the object of the invention to create a method for the computer-assisted analysis of buggy source code in a hardware description language, with which the location of the bugs in the source code is simplified.

This object is achieved by means of the method according to Patent Claim 1. Preferred embodiments of the invention are defined in the dependent claims.

The method according to the invention is used for the computer-assisted analysis of buggy source code in a hardware description language, the structure and the operation of an integrated circuit being described using the hardware description language and the buggy source code leading to an incorrect output of the integrated circuit. That is to say a simulation of the integrated circuit carried out with the source code leads to an output which deviates from an expected set-point value.

In the course of the method, a correction model is provided, which comprises a hierarchical structure of nodes arranged in a plurality of hierarchical levels, the nodes being transformation instructions, a transformation instruction describing a group of transformations which are to be applied to at least one type of a source code section and hereby change the source code section and a transformation instruction, which is a child node of another transformation instruction, constituting a subset of the group of transformations of the other transformation instruction. In a preferred variant, the hierarchical structure is realised by one or a plurality of hierarchy trees. Preferably, the set of transformations for the respective transformation instruction is determined by the functions which can be realised for the transformation instruction.

The correction model therefore constitutes a refining model of a multiplicity of transformation instructions, by which a set of transformations is specified in an ever finer manner, the refinement being represented in the hierarchical structure by means of a parent/child relationship (i.e. by a corresponding edge). The above term source code section is to be understood widely in this case and can comprise any elements in the source code, e.g. closed loops or syntactic statements, such as individual program lines, or any other desired elements.

In the course of the method according to the invention, the transformation instructions (i.e. the transformations from the corresponding group of transformations) from the hierarchical structure are applied to the buggy source code and those transformation instructions, which change the source code in such a manner that the changed source code leads to a correct output of the integrated circuit, are determined. A transformation instruction leads to a correct output if there is a transformation in the group of transformations specified by the transformation instruction, which leads to a correct output. At least a subset of the determined transformation instructions together with the associated source code section(s) to which the determined transformation instructions were applied are output as (possible) corrections. Preferably, the transformations are specified explicitly with their parameters which have led to the correct output. In a preferred variant, those determined transformation instructions, to which determined transformation instructions are not attached as child nodes, are output as corrections for each source code section, to which the transformation instructions are applied.

The method according to the invention stands out in that possible bug sources in the source code of an integrated circuit simulated by a hardware description language are described precisely by means of a self-refining correction model. The corrections determined by the method give the designer of the integrated circuit valuable indications as to the location in the source code at which a corresponding bug could be located, and with which change in the source code, this bug may possibly be corrected.

In a particularly preferred embodiment of the method according to the invention, the corrections are output with assigned priorities, the corrections for those determined transformation instructions to which no determined transformation instructions attach as child nodes having a higher priority. In this manner, the designer of the integrated circuit is informed about which transformation instructions are particularly relevant or concise, i.e. which transformation instructions relate to a particularly small subset of transformations.

In a particularly preferred embodiment of the invention, the determination of the transformation instructions which lead to a correct output of the integrated circuit takes place in such a manner that the transformation instructions are applied successively from the higher to the deeper hierarchical levels to the buggy source code, it being verified after the application of a transformation instruction whether the source code changed thereby leads to a correct output of the integrated circuit, transformation instructions which form child nodes of the applied transformation instruction only being applied to the buggy source code in the event of a correct output. In this case, the method can begin in the uppermost hierarchical level, but the method can also start in deeper hierarchical levels. In this embodiment, one makes use of the insight that in the event that a transformation instruction does not lead to a correct output, all transformation instructions which form child nodes of this transformation instruction also cannot lead to a correct output, as the child nodes are a subset of the transformations according to the transformation instruction of the parent node.

The transformation instructions can be defined on the basis of various criteria. In a preferred embodiment, a distinction is made between deterministic and non-deterministic transformation instructions. A deterministic transformation instruction is given by a deterministic function which depends on one or a plurality of parameters of the integrated circuit and in particular on the content of the source code section to which the deterministic transformation instruction is applied. By contrast, a non-deterministic transformation instruction designates an instruction which is independent of a deterministic function and thus comprises transformations with any desired parameters which can be used within the transformation instruction. It results from this definition of the deterministic and non-deterministic transformation instructions that a deterministic transformation instruction can be the child node of a non-deterministic transformation instruction, as a deterministic transformation instruction can be seen as a special variant of a non-deterministic transformation instruction. The inverse case, that a non-deterministic transformation instruction is a child node of a deterministic transformation instruction, is not possible.

In a further embodiment of the method according to the invention, the hierarchical structure comprises local transformation instructions, the respective transformations of which are always only applied to an individual source code section, it being possible however to apply each transformation in the transformation instruction to various source code sections of the same type. If appropriate, the hierarchical structure can also comprise global transformation instructions, the transformations of which can be applied to a plurality of source code sections simultaneously and e.g. change data structures. The hereinafter explained transformation instructions preferably constitute local transformation instructions.

In a preferred embodiment of the method according to the invention, the hierarchical structure in the uppermost hierarchical level comprises a non-deterministic transformation instruction, which replaces a source code section with a new source code section. Preferably, this non-deterministic transformation instruction comprises at least one of the following non-deterministic transformation instructions as child node:
a non-deterministic single-replacement transformation instruction, which replaces an assigned value of an individual assignment in the source code with a new value;
a non-deterministic multiple-replacement transformation instruction, which replaces all syntactic statements and in particular all assignments in a source code section with new assignments;
a non-deterministic additive transformation instruction, which adds one or a plurality of syntactic statements to a source code section.

An assignment is to be understood here and in the following to mean an expression with an equals sign, the assigned value of the assignment constituting the right side of the equals sign. The term syntactic statement is to be understood broadly here and in the following and can comprise any type of closed content in the source code. Preferably, the syntactic statement relates to a closed expression, such as a basic block, an assignment or a condition.

In a further preferred embodiment of the method according to the invention, the above-defined non-deterministic single-replacement transformation instruction comprises at least one of the following transformation instructions as child node:
a deterministic single-replacement transformation instruction, which replaces an assigned value of an individual assignment (without a condition) with a new value;
a deterministic conditional single-replacement transformation instruction, which replaces an assigned value of an individual assignment with a new value, taking account of a condition which depends on a non-deterministically determined value.

The term “taking a condition into account” is to be understood here and in the following to mean that the transformation instruction is only applied if the condition is satisfied. Analogously to the non-deterministic transformation instruction, “a non-deterministically determined value” is to be understood here and in the following to mean a value which is determined independently of a deterministic function.

In a further embodiment of the method according to the invention, the deterministic single-replacement transformation instruction comprises the following transformation instruction as child node:
a deterministic single-operator-replacement transformation instruction, which replaces an operator in the assigned value of an individual assignment with a new operator.

In a further variant of the invention, the deterministic conditional single-replacement transformation instruction comprises at least one of the following transformation instructions as child node:
a deterministic conditional single-replacement transformation instruction, which replaces an assigned value of an individual assignment, taking account of a condition which depends on the current state and the current input (i.e. one or a plurality of current input values) of the integrated circuit;
a deterministic conditional single-replacement transformation instruction, which replaces an assigned value of an individual assignment, taking account of a condition which depends on the current state and the current input and one or a plurality of previous states and one or a plurality of previous inputs of the integrated circuit, a previous input comprising one or a plurality of previous input values.

The current or the previous states and the current or the previous inputs of the integrated circuit arise as a result in the course of the simulation of the integrated circuit by the source code.

In a further embodiment of the method according to the invention, a non-deterministic multiple-replacement transformation instruction comprises the following transformation instruction as child node:
a non-deterministic conditional deactivation transformation instruction, which replaces a syntactic statement in a source code section, taking account of a condition which depends on a non-deterministically determined value.

In a further variant, the non-deterministic conditional deactivation transformation instruction comprises at least one of the following transformation instructions as child node:
a non-deterministic conditional deactivation transformation instruction, which replaces a syntactic statement, taking account of a condition which depends on the current state and the current input of the integrated circuit;
a non-deterministic conditional deactivation transformation instruction, which replaces a syntactic statement, taking account of a condition which depends on the current state and the current input and one or a plurality of previous states and one or a plurality of previous inputs of the integrated circuit;
a non-deterministic conditional deactivation transformation instruction, which replaces a syntactic statement, taking account of a predetermined (i.e. already existing) condition.

In a further variant of the method according to the invention, the non-deterministic additive transformation instruction comprises the following transformation instruction as child node:
a non-deterministic conditional additive transformation instruction, which adds one or a plurality of syntactic statements in a source code section and activates these added syntactic statements, taking account of a condition which depends on a non-deterministically determined value.

In a further variant of the method according to the invention, the non-deterministic additive transformation instruction comprises at least one of the following transformation instructions:
a non-deterministic conditional copying transformation instruction, which copies one or a plurality of syntactic statements and activates the copied syntactic statements, taking account of a condition which depends on a non-deterministically determined value;
a non-deterministic copying transformation instruction, which copies one or a plurality of syntactic statements (without a condition);
a non-deterministic conditional copying transformation instruction, which copies one or a plurality of syntactic statements and activates the copied syntactic statements, taking account of a condition which depends on the current state and the current input of the integrated circuit;
a non-deterministic conditional copying transformation instruction, which copies one or a plurality of syntactic statements and activates the copied syntactic statements, taking account of a condition which depends on the current state and the current input and one or a plurality of previous states and one or a plurality of previous inputs of the integrated circuit;
a non-deterministic conditional copying transformation instruction, which copies one or a plurality of syntactic statements and activates the copied syntactic statements, taking account of a predetermined (already existing) condition.

The method according to the invention can be applied to buggy source code in any desired hardware description languages. In preferred variants, the method is used for the hardware description languages Verilog and/or VHDL and/or SystemC, which have been known for a long time from the prior art.

In addition to the previously described method, the invention further comprises a computer program product with a program code stored on a machine-readable carrier for carrying out the method according to the invention or one or a plurality of preferred variants of the method according to the invention when the program code is executed on a computer. The invention furthermore relates to a computer program with a program code for carrying out the method according to the invention or one or a plurality of variants of the method according to the invention when the program code is executed on a computer.

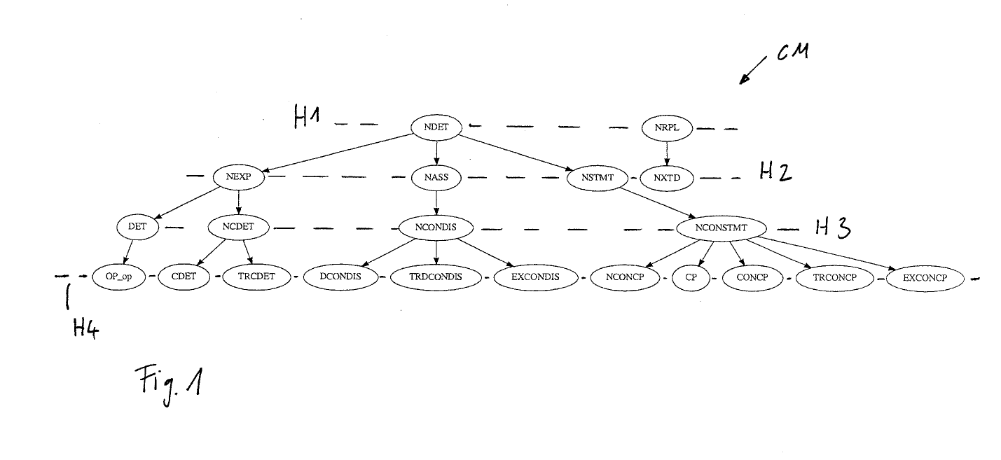

Exemplary embodiments of the invention are described in detail hereinafter on the basis of the attached FIG. 1. This FIGURE shows an embodiment of a hierarchical structure in the form of a hierarchy tree made up of transformation instructions, which is used in a variant of the method according to the invention.

In the following, the method according to the invention is described on the basis of the hardware description language Verilog, by which a corresponding integrated circuit or a chip is designed and by which the behaviour of the integrated circuit can be simulated temporally on the basis of a specification of an input sequence. The method according to the invention is not limited to the hardware description language Verilog however, but rather can also be used for other description languages, if necessary.

It is the aim of the invention to localise bugs in a buggy source code in a hardware description language, the buggy source code leading to an output deviating from the expected correct output for a predetermined input sequence on the basis of the simulation of the integrated circuit. The method according to the invention uses a refining correction model CM for localising bugs in the source code, which as a hierarchy tree is built up from a multiplicity of transformation instructions which combine groups of transformations in a suitable manner. The transformations change the source code in a suitable manner.

FIG. 1 shows an exemplary embodiment of such a hierarchy tree. This tree comprises four hierarchical levels H1, H2, H3, H4, wherein the individual nodes of the tree are illustrated as ellipses which name the transformation instruction assigned to the respective node with corresponding reference symbols. Between the nodes of the various hierarchical levels, there are edges which lead from a parent node in one hierarchical level to one or a plurality of child nodes of the next deepest hierarchical level. There is a relation between a parent node and a child node such that a child node constitutes a refinement of the transformation instruction of the parent node. Refinement here means that the refined transformation instruction of the child node constitutes a subset of the group of transformations which is represented by the transformation instruction of the parent node. That is to say, if a bug in the source code can be corrected with a transformation instruction which is the child node of another transformation instruction, then this bug can also be corrected with the transformation instruction according to the parent node.

In the following, the above-described transformation instructions are also referred to as generic transformations, whereas the transformations contained therein constitute the actual transformations. In Table 1 shown below, the generic transformations shown in FIG. 1 in individual hierarchical levels are explained in detail. The first column of the table designates the name of the generic transformation. The second column contains the name of the generic transformation (i.e. the parent node), which is refined by the generic transformation of the first column. The third column names a pattern, which describes the source code section to which the corresponding generic transformation according to the first column is applied. The fourth column includes the correspondingly transformed source code section after the application of the generic transformation. The fifth column contains a textual description of the generic transformation.

The generic transformations shown in the Table 1 are merely exemplary and further modifications and additions of transformations can also be used. It is essential to the invention however, that the transformations are described by a hierarchical structure, a child node constituting a subset of the group of transformations of the corresponding parent node. In this manner, an efficient localisation of bugs in the source code of the hardware description language is achieved. In FIG. 1 and Table 1, a distinction is made between local transformations and global transformations. All transformations which emanate from the NDET node are local transformations, which means that these transformations are always applied only locally to one source code section and not simultaneously to a plurality of different source code sections in the source code. In contrast to local transformations, global generic transformations, which are the transformations NRPL and NXTD of FIG. 1, are applied to a plurality of source code sections in the source code. In this case, a distinction is made between different types of source code sections which are explained in the following.

A source code section in the form of a syntactic statement designates a predetermined type of statement in the source code and relates e.g. to an isolated program line, which is normally terminated by a semicolon. A set of syntactic statements comprises a plurality of such statements. Special cases of syntactic statements are expressions in the form of variable assignments (e.g. a=b), wherein a corresponding condition is also to be understood as a variable assignment which constitutes the argument of an if instruction. A plurality of syntactic statements of a source code block are designated with stmt_block in the pseudocode in the third and fourth columns of Table 1. An individual statement is designated with stmt or stmt1 or stmt2.

In Table 1, a further distinction is made between deterministic generic transformations and non-deterministic generic transformations. A deterministic generic transformation is given by a deterministic function which is designated in Table 1 with DET and depends on one or a plurality of parameters of the integrated circuit, particularly on the content of the source code section which is modified by the transformation and/or on current or on previous states or inputs of the simulated integrated circuit. In the case of otherwise identical parameters, a deterministic generic transformation instruction always describes a subset of the transformations of a non-deterministic generic transformation, i.e. a non-deterministic transformation instruction comprises transformations of all corresponding deterministic transformation instructions. Generally, in the present application the term “deterministic” designates a dependence on one or a plurality of parameters of the integrated circuit, whereas “non-deterministic” represents the independence from parameters of the integrated circuit. The syntax of the third and fourth columns of Table 1 can be understood by a person skilled in the art and is not explained in detail. The expression a=VAR?d: b+c means that the variable a is assigned the value of (b+c) if VAR contains the value “false” or “0”. Otherwise, the variable a is assigned the value of the variable d. The expression if (VAR) means that the subsequent transformation is only carried out if VAR assumes a particular value (e.g. 1, if VAR represent one bit).

TABLE 1

| | | | Transformed source | |
|---|---|---|---|---|
| Name | refines | is applied to | code section | Description |
| NDET | | stmt_block; | non-deterministic | Replace a set of statements in |
| | | | | the source code block |
| | | | | stmt_block with a non- |
| | | | | deterministic source code block. |
| NEXP | NDET | a = b + c; | a = NEWVAR; | Replace an assigned value of an |
| | | | | assignment or a condition (i.e. |
| | | | | the right side of an equation |
| | | | | from the source code) non- |
| | | | | deterministically with a new |
| | | | | value in the form of the variable |
| | | | | NEWVAR. |
| DET | NEXP | a = b + c; | a = DET(b, c); | Replace an assigned value of an |
| | | | | assignment with a new deterministically |
| | | | | determined value |
| | | | | DET(b, c), which depends on the |
| | | | | variables b and c of the original |
| | | | | assignment. |
| OP_op | DET | a = b + c; | a = b op c, where op is | Replace an operator in an assignment |
| | | | e.g. -, *, ... | with a new operator |
| | | | | op, using the same variables of |
| | | | | the original assignment, where |
| | | | | op can be any operator which is |
| | | | | allowed in the context. |
| NCDET | NEXP | a = b + c; | a = NEWVAR ? | Replace an assigned value of an |
| | | | DET(b, c): b + c; | assignment with a new deterministically |
| | | | | determined value |
| | | | | DET(b, c) as a function of the |
| | | | | value of a non-deterministically |
| | | | | assigned variable NEWVAR. |
| CDET | NCDET | a = b + c; | a = (DET(state) ? | Replace an assigned value of an |
| | | | DET(b, c): b + c); | assignment with a new deterministically |
| | | | | determined value |
| | | | | DET(b, c) as a function of the |
| | | | | current state and the current |
| | | | | input of the integrated circuit, |
| | | | | where the current state can comprise |
| | | | | the overall state of the |
| | | | | circuit or else a subset of the |
| | | | | state bits or internal signals |
| | | | | which are selected for determining |
| | | | | the condition. |
| TRCDET | NCDET | a = b + c; | a = (DET(trace) ? | Replace an assigned value of an |
| | | | DET(b, c): b + c); | assignment with a new deterministically |
| | | | | determined value |
| | | | | DET(b, c) as a function of the |
| | | | | history (trace) comprising the |
| | | | | current state and the current |
| | | | | input and also one or a plurality |
| | | | | of previous states and previous |
| | | | | inputs of the integrated circuit |
| | | | | (this transformation enables the |
| | | | | changing of the state space of |
| | | | | the integrated circuit). |
| NASS | NDET | stmt; | non-deterministic | Replace all syntactic statements |
| | | | | in a source code block with new |
| | | | | non-deterministic statements. |
| NCONDIS | NASS | stmt; | if (NEWVAR) stmt; | Deactivate a statement as a function |
| | | | | of a condition which depends |
| | | | | on the value of a non- |
| | | | | deterministically assigned variable |
| | | | | NEWVAR. |
| DCONDIS | NCONDIS | a = b; | if(DET(state)) stmt; | Deactivate a statement as a function |
| | | | | of a condition which depends |
| | | | | on the current state and |
| | | | | the current input of the integrated |
| | | | | circuit. |
| TRDCONDIS | NCONDIS | a = b; | if(DET(trace)) stmt; | Deactivate a statement as a function |
| | | | | of a condition which depends |
| | | | | on the history (trace) |
| | | | | comprising the current state and |
| | | | | the current input and also one or |
| | | | | a plurality of previous states and |
| | | | | previous inputs of the integrated |
| | | | | circuit. |
| EXCONDIS | NCONDIS | a = b; | if(OP(cond)) stmt; | Deactivate a statement as a function |
| | | | | of an already existing condition |
| | | | | (OP means “cond == true” |
| | | | | or “cond == false”). |
| NSTMT | NDET | stmt1; | stmt1; NEWSTMT, | Add one or a plurality of statements |
| | | stmt2; | stmt2; | NEWSTMT, which can |
| | | | | realise non-deterministic functions. |
| NCONSTMT | NSTMT | stmt1; | stmt1; if (NEWVAR) | Add a new block of statements, |
| | | stmt2; | NEWBLOCK; | where the block is activated as a |
| | | | stmt2; | function of a non- |
| | | | | deterministically assigned condition. |
| NCONCP | NCONSTMT | stmt1; | stmt1; if (NEWVAR) | Copy a block of statements, |
| | | stmt2; | COPIED-BLOCK; | where the block is activated as a |
| | | | stmt2; | function of a non- |
| | | | | deterministically assigned condition. |
| CP | NCONSTMT | stmt1; | stmt1; | Copy a block of statements (independently |
| | | stmt2; | COPIED-BLOCK; | of a condition). |
| | | | stmt2; | |
| CONCP | NCONSTMT | stmt1; | stmt1; if | Copy a block of statements, |
| | | stmt2; | (DET(state)) | where the block is activated as a |
| | | | COPIEDBLOCK; | function of the current state and |
| | | | stmt2; | the current input of the integrated |
| | | | | circuit, where the current |
| | | | | state can comprise the overall |
| | | | | state of the circuit or else a sub- |
| | | | | set of the state bits or internal |
| | | | | signals which are selected for |
| | | | | determining the condition. |
| TRCONCP | NCONSTMT | stmt1; | stmt1; if | Copy a block of statements, |
| | | stmt2; | (DET(trace)) | where the block is activated as a |
| | | | COPIEDBLOCK; | function of the history (trace) |
| | | | stmt2 | comprising the current state and |
| | | | | the current input and also one or |
| | | | | a plurality of previous states and |
| | | | | previous inputs of the integrated |
| | | | | circuit (this transformation enables |
| | | | | the changing of the state |
| | | | | space of the integrated circuit). |
| EXCONCP | NCONSTMT | stmt1; | stmt1; if (OP(cond)) | Copy a block of statements, |
| | | stmt2; | COPIEDBLOCK; | where the block is activated as a |
| | | | stmt2 | function of an already existing |
| | | | | condition (OP means “cond == |
| | | | | true” or “cond == false”). |
| NRPL | | a = b; c = a + b, | a = NEWVAR1; c = | Replace each write access to a |
| | | a = d; e = c + a; | a + b; | variable with a new non- |
| | | | a = NEWVAR2; | deterministic assignment. |
| | | | e = c + a; | |
| NXTD | NRPL | struct { int | struct { int a, b; | Expand a data structure with a |
| | | a, b; }; | SOMETYPE | new member variable, where all |
| | | | NEWVAR; } | calculations of a variable which |
| | | | | instantiates this data structure |
| | | | | can depend on the new member |
| | | | | variable. |

In the following, a process of a variant of the method according to the invention is explained by way of example on the basis of the following pseudocode. In this variant, in the hierarchy tree of FIG. 1, the generic transformations which lead to a correct output of a corresponding specification in the form of an input sequence for an integrated circuit designed with the hardware description language are determined. The implementation of the invention is contained within the function loop function, which defines the function “debug” which depends on the design D of the integrated circuit, the specification S of the input sequence and the refining correction model CM. By means of the pseudocode, a graph G is built up from those nodes of the hierarchy tree of FIG. 1 which specify transformation instructions, by which a correct output is obtained on the basis of the specification S. A loop which is repeated for a plurality of values is designated with foreach/done in the following pseudocode. Furthermore, a code execution which is linked to a condition is designated with if/fi. The pseudocode reads as follows:

| 1 | function debug (design D, specification S, correction model |
|---|---|
| CM) | |
| 2 | Queue R = all generic transformations which do not re- |
| | fine any other generic transformations |

| | |
|---|---|
| 3 | Queue Q= empty queue |
| 4 | Graph G = empty graph which stores “result”; |
| 5 | foreach T1∈R do |
| 6 | foreach location L , where T1 can be applied do |

| | |
|---|---|
| 7 | Q.append (T1, L); |

| | |
|---|---|
| 8 | done |
| 9 | foreach C = (T1, L) ∈Q do |

| | |
|---|---|
| 10 | D′= application of C to D; |
| 11 | result= validate/verify (D′, S); |
| 12 | if (result == valid) |

| | |
|---|---|
| 13 | G.addNodeAndEdges(C); |
| 14 | foreach T2, which refines T1 do |

| | |
|---|---|
| 15 | Q.append(T2, L); |

| | |
|---|---|
| 16 | done |

| | |
|---|---|
| 17 | fi |

| | |
|---|---|
| 18 | done |
| 19 | return G; |

| | |
|---|---|
| 20 | end function; |

In the above pseudocode, a queue R is formed in line 2, which comprises all generic transformations which do not refine any other generic transformations in the correction model CM, i.e. the queue R consists of the transformations in the uppermost hierarchical level which is the hierarchical level H1 of the hierarchy tree of FIG. 1. According to lines 3 to 8 of the pseudocode, all allowed actual transformations from the queue R are determined for the buggy source code according to the design D. An actual transformation designates the corresponding transformation instruction T1 with those locations L in the source code, to which the transformation instruction can be applied. These actual transformations are added by the function Q.append to the queue Q. Finally, according to lines 9 to 18, all actual transformations C=(T1, L) from the queue Q are applied to the source code, resulting in a modified design D′. In line 12 it is validated, whether according to the input sequence S a valid result “result” has been obtained, the result being valid if the design D′ leads to a correct output according to the transformed source code. If this is the case, the corresponding transformation instruction is added as node with associated edge in the initially empty graph G which also contains the refining information (line 13). Subsequently, all refining generic transformations T2 of the corresponding transformation instruction T1, i.e. the corresponding child nodes of the original generic transformation T1, are added to the queue Q with the corresponding locations, to which the transformations T2 can be applied (lines 14 to 16 of the pseudocode). The loop terminates only if the queue has been executed completely and so is empty. Then the entire search space of possible transformations defined by the CM has been processed. As a final result, one eventually receives a graph G which contains all actual transformations.

An example of the process of an embodiment of the method according to the invention is explained hereinafter for clarification on the basis of the hardware description language Verilog. The following Verilog source code is considered in the process:

| | |
|---|---|
| 1 | module example (rst, elk, op, a, b, |

| | |
|---|---|
| 2 | c_low, c_high); |

| | |
|---|---|
| 3 | |
| 4 | parameter IW=2; |
| 5 | parameter DW=16; |
| 6 | |
| 7 | input rst, clk; |
| 8 | input [IW−1:0] op; |
| 9 | input [DW−1:0] a, b; |
| 10 | output [DW−1:0] c_low, c_high; |
| 11 | output oflow; |
| 12 | |
| 13 | reg [DW+DW:0] tmp; |
| 14 | reg [DW−1:0] c_low, c_high; |
| 15 | reg oflow; |
| 16 | |
| 17 | always @ (posedge clk or posedge rst) |
| 18 | begin |

| | |
|---|---|
| 19 | if (rst) begin |

| | |
|---|---|
| 20 | tmp <= 0; |
| 21 | oflow <= 0; |

| | |
|---|---|
| 22 | end else |

| | |
|---|---|
| 23 | case (op) |

| | |
|---|---|
| 24 | 0: tmp = a + b; |
| 25 | //bug -- wrong operator |
| 26 | // 1: tmp = a − b; |
| 27 | 1: tmp = a + b; |
| 28 | 2: tmp = a * b; |

| | |
|---|---|
| 29 | endcase |

| | |
|---|---|
| 30 | {oflow, c_high, c_low} = tmp; |

| | |
|---|---|
| 31 | end |
| 32 | |
| 33 | endmodule |

As Verilog is known per se as a hardware description language, the above commands of the source code are not explained in detail. It is just relevant that the source code contains a bug in line 27. A subtraction should be calculated there, as is indicated by the comment lines 25 and 26. Actually, however an addition, namely tmp=a+b, is calculated. In the course of the simulation of the integrated circuit based on the above source code, three input sequences A, B and C are considered, which are indicated in the following table:

| ID | op | a | b | Actual | Set point |
|---|---|---|---|---|---|
| A | 0 | 7 | 5 | 12 | 12/ok |
| B | 1 | 7 | 5 | 12 | 2/bug |
| C | 2 | 7 | 5 | 35 | 35/ok |

In the above table, the first column designates the identity of the input sequence and the second to fourth columns reproduce the values of the operands op, a and b. Further, the actual output value of tmp is indicated in the fifth column and the (correct) set-point output value of tmp is indicated in the sixth column. In the input sequence A, the operand op assumes the value 0 according to the above Verilog source code, whereas the operand a has the value 7 and the operand b has the value 5. As op=0, this leads in accordance with the case instruction in line 23 to tmp=a+b being calculated, so that in line 30 for {oflow, c_high, c_low}=tmp, the value 12 is finally output. The input sequence A therefore leads to a correct output (actual value=set-point value), which is indicated in the sixth column by “ok”. By contrast, the input sequence B leads to the output value 12 of tmp, which is not the correct output of tmp=2, however. The input sequence C leads in turn to a correct output value.

Starting from this Verilog source code and the corresponding input sequences, transformations from the above transformation instructions according to FIG. 1 are then applied. For example, one starts with the three generic transformations in NEXP, DET and OP_op, where OP_op according to FIG. 1 refines the transformation instruction DET and the transformation instruction DET refines the transformation instruction NEXP. Each of these generic transformations replaces an assignment, i.e. the right side of an equation, as follows:

NDET replaces the assignment with a new, non-deterministically assigned variable. By applying this generic transformation to line 30 of the above source code, an actual transformation is obtained, which leads to the following code:

{oflow, c_high, c_low}=NEWVAR;

The transformation instruction DET replaces an assignment with a deterministic function which depends on the variables in the expression. By applying this transformation instruction to line 30 of the above source code, an actual transformation is obtained, which modifies line 30 as follows:

{oflow, c_high, c_low}=DET(tmp);

The transformation instruction OP_op replaces an operator on the right side of an assignment with another operator. In the example described here, by applying this transformation instruction to line 30, a negation instead of the identity function is carried out, which leads to an actual transformation, which corresponds to the following code in line 30:

{oflow, c_high, c_low}=OP(!, tmp);

In the embodiment described here, the transformation instruction NDET is initially applied to line 30, and subsequently the refining transformations are carried out. By applying NDET to line 30 of the above source code, it is possible to create a correct output in that the expected set-point output value is assigned to the new variable NEWVAR. Consequently, the refining transformation instruction DET is then applied to line 30 of the source code. However, for the input sequence A and the input sequence B, the internal signal tmp has the value 12, whereas the output signal in both cases should be different. This cannot be realised with a deterministic function. Thus, the bug in the source code cannot be overcome by means of the transformation instruction DET which is applied to line 30. Nevertheless, the less refining transformation NDET in the higher hierarchical level was successful. Consequently NDET, which is applied to line 30, constitutes a correction C₁=(NDET, 29) for the buggy source code.

The method can then be continued in that the transformation instruction NDET is applied to line 27 of the above source code, which leads to the following modification:

1: tmp=NEWVAR;

This transformation in turn enables the generation of a correct output for all input sequences. Consequently, the refining transformation instruction DET is then applied to line 27, which leads to the following modified program line:

1: tmp=DET(a, b);

With these transformations also, a correct output can be generated for all input sequences a to c. If the transformation instruction OP_op is then applied to line 27, where the operator “+” is replaced with the operator the following modified program line results:

1: tmp−op(−, a, b);

This transformed Verilog source code also generates the correct output value for all input sequences. As there are no further refining transformations for OP_op, a further possible correction is C₂=(OP_op, 26). According to the refining relation based on the hierarchy tree of FIG. 1, the transformation instruction OP_op is the most refining transformation instruction, as it is arranged in a deeper hierarchical level than the transformation instructions DET and NDET respectively. Consequently, an output is generated, in which the correction C₂=(OP_op, 26) is classified with a higher priority for checking by the designer of the circuit than the correction C₁=(NDET, 29).

According to the invention, a prioritised output of possible corrections for a buggy source code in a hardware description language can be created in a suitable manner, so that the designer of the integrated circuit hereby receives information, with which he can locate the bug in the source code in a fast manner.

The determination according to the invention of corresponding transformation instructions can be implemented in various ways, wherein different implementation variants are outlined briefly hereinafter. The realisation of a corresponding implementation forms part of the expertise of a person skilled in the art and is therefore not described in detail.

Two resource intensive steps are required for implementing the method. On the one hand, the transformation instructions must be applied to the various source code sections and on the other hand, the validity of the transformed source code must be checked with respect to the correspondingly expected output. These two steps can be carried out independently of one another or interwoven. The following technologies can be used for implementing these steps:
explicit simulation-based approaches, e.g.
   explicit application of transformations according to the transformation instructions and subsequent simulation of the integrated circuit on the basis of the transformed source code, in order to hereby check the correctness of the output;
   a simulation which takes account of unknown values;
   path tracing methods
formal technologies, such as e.g.
   a symbolic simulation;
   term rewriting and in and-inverter graphs;
   reasoning engines for deriving conclusions (boolean satisfiability (SAT), satisfiability modulo theories (SMT), binary decision diagrams (BDD), automatic test pattern generation (ATPG));
hybrid technologies, such as e.g.
   concolic simulation
   symbolic trajectory evaluation

All of these methods require a few modifications in order to carry out and to check the actual transformations. This is explained hereinafter for simulation-based approaches, formal techniques and hybrid techniques.

In a simulation-based approach, the actual transformation from the corresponding transformation instructions is applied to the source code, which leads to a modified description, on the basis of which the integrated circuit can be simulated. The checking of the validity of the output of the simulated circuit is readily possible for those actual transformations which replace a logical section of the source code with a new logic. In this case, a standard simulation is carried out, in order to check the behaviour of the integrated circuit on the basis of the transformed design. In the event that no logic is inserted, e.g. by the generic transformation NDET or DET from FIG. 1, the simulation must be modified. For NDET, possible parameters for this transformation are listed and the output is checked via a simulation on the basis of these parameters. For DET, partial truth tables are additionally generated in order to check whether the parameters of the transformation can be generated deterministically from other signals in the circuit design.

Alternatively, the simulation-based method can be carried out on a netlist. To this end, the source code is synthesised in a netlist. During this synthesis step, the relations between source code and elements in the netlist are obtained. As a result, possible corrections on the netlist can be mapped onto the source code. Then, one or a plurality of transformation instructions are applied directly to the netlist and the result is checked for each simulation as above.

When using formal techniques, an actual transformation can be applied in such that the source code is changed directly and a formal model is generated from the transformed source code, which is subsequently processed by a reasoning engine. Alternatively, a plurality of actual transformations can be symbolically added to the formal model which was generated from the original source code. As a result, a plurality of actual transformations is analysed in a single pass of the reasoning engine. For simple logic replacements, the transformation can in turn be inserted directly into the source code. For the generic transformation NDET, new symbolic variables are inserted, value assignments being undertaken by the reasoning engine. For the generic transformation DET, additional limitations are added to the formal model, in order to guarantee the deterministic behaviour. Some reasoning engines provide direct mechanisms in order to formulate such limitations, for example SMT solvers model so-called “uninterpreted functions”.

Checking the validity of a transformed design can be achieved in the case of formal techniques by comparing the specification of a corresponding input sequence with the transformed integrated circuit. The reasoning engine in this case finds contradictions between the specification and the transformed circuit design. If the specification is for example given by means of expected values for input sequences which lead to an incorrect output, an individual input sequence or a plurality of input sequences can be processed simultaneously by a single formal model.

Within the method according to the invention, hybrid techniques can also be used, which are based both on simulations and on formal techniques. These techniques typically reduce the cardinality of the proof method compared to a formal reasoning engine, which leads to less computing complexity. Which parts of the problem are processed by formal methods and which are processed by simulation-based methods can essentially be adjusted via heuristics.

In the worst case, each generic transformation must be applied to every possible source code section in the circuit design. The number of actual transformations therefore becomes very large. Therefore, if necessary, further optimisation techniques can be used in order to reduce this number. In this case, structural approaches are known, which analyse the structure of control and data flow graphs. As a result, the number of source code sections for which e.g. NDET has to be applied can be reduced.

The method according to the invention described in the foregoing has a range of advantages. In particular, the method allows the analysis of buggy source code of a hardware description language so that possible corrections are determined using a hierarchically built correction model comprising a plurality of transformation instructions. The hierarchical structure of the transformation instructions is built such that a transformation instruction, which is the child node of a transformation instruction of a higher hierarchical level, constitutes a subset of the transformations according to the transformation instruction of the higher hierarchical level. That is to say the cause of the bug is ever more constrained in a suitable manner by means of the use of the hierarchical structure. By means of a prioritised output of possible corrections, in which the corrections from deeper hierarchical levels receive a higher priority, the designer of the integrated circuit is also informed about which transformation instructions and thus linked corrections were particularly concise in the sense that they already specify small subsets of transformations.

1. A method for the computer-assisted analysis of buggy source code in a hardware description language, wherein the structure and the operation of an integrated circuit is described using the hardware description language and the buggy source code leads to an incorrect output of the integrated circuit, in which:
a correction model is provided, which comprises a hierarchical structure of nodes arranged in a plurality of hierarchical levels, the nodes being transformation instructions, wherein a transformation instruction describes a group of transformations which are to be applied to at least one type of a source code section and hereby change the source code section and wherein a transformation instruction, which is a child node of another transformation instruction, constitutes a subset of the group of transformations of the other transformation instruction; and
the transformation instructions from the hierarchical structure are applied to the buggy source code and those transformation instructions, which change the source code in such a manner that the changed source code leads to a correct output of the integrated circuit, are determined, wherein at least a subset of the determined transformation instructions together with the associated source code section(s), to which the determined transformation instructions were applied, are output as corrections.

2. The method according to claim 1, in which the corrections are output with assigned priorities, wherein the corrections for those determined transformation instructions to which no determined transformation instructions attach as child nodes have a higher priority.

3. The method according to claim 1, in which in the course of the determination of those transformation instructions, the transformation instructions are applied successively from the higher to the deeper hierarchical levels to the buggy source code, wherein it is verified after the application of a transformation instruction whether the source code changed thereby leads to a correct output of the integrated circuit, wherein transformation instructions which form child nodes of the applied transformation instruction are only applied to the buggy source code in the event of a correct output.

4. The method according to claim 1, in which the transformation instructions comprise at least one of deterministic and non-deterministic transformation instructions, wherein a deterministic transformation instruction is given by a deterministic function which depends on one or a plurality of parameters of the integrated circuit and in particular on the content of the source code section to which the deterministic transformation instruction is applied, and wherein a non-deterministic transformation instruction is independent of a deterministic function which depends on one or a plurality of parameters of the integrated circuit.

5. The method according to claim 1, in which the hierarchical structure comprises local transformation instructions, the transformations of which are always only applied to an individual source code section in the source code.

6. The method according to claim 1, in which the hierarchical structure comprises global transformation instructions, the transformations of which are applied to a plurality of source code sections in the source code simultaneously.

7. The method according to claim 4, in which the hierarchical structure in the uppermost hierarchical level comprises a non-deterministic transformation instruction, which replaces a source code section with a new source code section.

8. The method according to claim 7, in which the non-deterministic transformation instruction in the uppermost hierarchical level comprises at least one of the following non-deterministic transformation instructions as child node:
a non-deterministic single-replacement transformation instruction, which replaces an assigned value of an individual assignment in the source code with a new value;
a non-deterministic multiple-replacement transformation instruction, which replaces all syntactic statements in a source code section with new statements;
a non-deterministic additive transformation instruction, which adds one or a plurality of syntactic statements to a source code section.

9. The method according to claim 8, in which the non-deterministic single-replacement transformation instruction comprises at least one of the following transformation instructions as child node:
a deterministic single-replacement transformation instruction, which replaces an assigned value of an individual assignment in the source code with a new value;
a deterministic conditional single-replacement transformation instruction, which replaces an assigned value of an individual assignment in the source code with a new value, taking account of a condition which depends on a non-deterministically determined value.

10. The method according to claim 9, in which the deterministic single-replacement transformation instruction comprises the following transformation instruction as child node:
a deterministic single-operator-replacement transformation instruction, which replaces an operator in the assigned value of an individual assignment with a new operator.

11. The method according to claim 9, in which the deterministic conditional single-replacement transformation instruction comprises at least one of the following transformation instructions as child node:
a deterministic conditional single-replacement transformation instruction, which replaces an assigned value of an individual assignment in the source code with a new value, taking account of a condition which depends on the current state and the current input of the integrated circuit;
a deterministic conditional single-replacement transformation instruction, which replaces an assigned variable of an individual assignment, taking account of a condition which depends on the current state and the current input and one or a plurality of previous states and one or a plurality of previous inputs of the integrated circuit.

12. The method according to claim 8, in which the non-deterministic multiple-replacement transformation instruction comprises the following transformation instruction as child node:
a non-deterministic conditional deactivation transformation instruction, which replaces a syntactic statement in a source code section, taking account of a condition which depends on a non-deterministically determined value.

13. The method according to claim 12, in which the non-deterministic conditional deactivation transformation instruction comprises at least one of the following transformation instructions as child node:
a deterministic conditional deactivation transformation instruction, which replaces a syntactic statement, taking account of a condition which depends on the current state and the current input of the integrated circuit;
a non-deterministic conditional deactivation transformation instruction, which replaces a syntactic statement, taking account of a condition which depends on the current state and the current input and one or a plurality of previous states and one or a plurality of previous inputs of the integrated circuit;
a non-deterministic conditional deactivation transformation instruction, which replaces a syntactic statement, taking account of a predetermined condition.

14. The method according to claim 8, in which the non-deterministic additive transformation instruction comprises the following transformation instruction as child node:
a non-deterministic conditional additive transformation instruction, which adds one or a plurality of syntactic statements in a source code section and activates the added syntactic statements, taking account of a condition which depends on a non-deterministically determined value.

15. The method according to claim 14, in which the non-deterministic conditional additive transformation instruction comprises at least one of the following transformation instructions as child node:
a non-deterministic conditional copying transformation instruction, which copies one or a plurality of syntactic statements and activates the copied syntactic statements, taking account of a condition which depends on a non-deterministically determined value;
a non-deterministic copying transformation instruction, which copies one or a plurality of syntactic statements;
a non-deterministic conditional copying transformation instruction, which copies one or a plurality of syntactic statements and activates the copied syntactic statements, taking account of a condition which depends on the current state and the current input of the integrated circuit;
a non-deterministic conditional copying transformation instruction, which copies one or a plurality of syntactic statements and activates the copied syntactic statements, taking account of a condition which depends on the current state and the current input and one or a plurality of previous states and one or a plurality of previous inputs of the integrated circuit;
a non-deterministic conditional copying transformation instruction, which copies one or a plurality of syntactic statements and activates the copied syntactic statements, taking account of a predetermined condition.

16. The method according to claim 1, in which the hardware description language comprises at least one of: Verilog, VHDL, and SystemC.

17. A computer program product with program code, which is stored on a non-transitory machine-readable carrier, for carrying out a method according to claim 1 when the program code is executed on a computer.

18. (canceled)
